(19) United States
(12) Patent Application Publication
(10) Pub. No.: US 2013/0151311 A1
(43) Pub. Date: Jun. 13, 2013

(54) PREDICTION OF CONSUMER BEHAVIOR DATA SETS USING PANEL DATA

(71) Applicants: Bradley Hopkins Smallwood, Palo Alto, CA (US); Sean Michael Bruich, Palo Alto, CA (US)

(72) Inventors: Bradley Hopkins Smallwood, Palo Alto, CA (US); Sean Michael Bruich, Palo Alto, CA (US)

(21) Appl. No.: 13/677,889

(22) Filed: Nov. 15, 2012

Related U.S. Application Data
(60) Provisional application No. 61/560,288, filed on Nov. 15, 2011.

(51) Int. Cl. G06Q 30/02; G06Q 50/00

(52) U.S. Cl. CPC G06Q 30/0202; G06Q 50/01
USPC 705/7.31

(57) ABSTRACT

Embodiments of the invention combine information from different data sets, such as social networks, vendor systems, and/or panels, each data set comprising statistics about past consumer behavior (e.g., product purchases). The result of the combination is a model that, when applied to statistics about purchases of a particular product, produces predicted consumer behavior statistics about the particular product that are more accurate than the data of any given one of the different data sets when taken in isolation.

### CROSS REFERENCE TO RELATED APPLICATIONS

This application is a conversion of Provisional U.S. Application No. 61/560,288, filed Nov. 15, 2011, which is incorporated by reference in its entirety.

This application is also related to a Provisional U.S. Application No. 61/560,287, filed Nov. 15, 2011, which is incorporated by reference in its entirety.

### BACKGROUND

The present invention generally relates to the field of computer data storage and retrieval, and more specifically, to predicting consumer behavior data sets using panel data.

Disseminators of digital content via the Internet are often interested in predicting consumer behavior. For example, advertisers that provide digital products for display on web sites are interested in estimating the number of impressions (total separate displays) that a particular product produced with respect to different demographic attributes of interest, such as different age groups, males or females, those with particular interests (e.g., tennis), and the like.

In the context of television products, selected surveying panels of households and/or individuals can be directly or indirectly surveyed regarding their television viewing habits. However, in order to be statistically representative these panels must be of a substantial size, and thus panels are of little utility in contexts where there is not a large audience to be surveyed. For example, few, if any, individual web sites have the number of viewers needed to form a panel providing sufficient accuracy.

Some web sites, such as social networking sites, have a very large user base and thus have access to a wealth of demographic and statistical data. For example, user data on social networking sites typically includes information such as age, sex, and interests, as well as users' historical reactions to products previously presented. However, the user base of these social networking sites typically does not perfectly represent, demographically, the population in general or that of another web site on which products might be placed. For example, the user demographics of a given social networking site are unlikely to perfectly match that of an online news web site. Thus, although the user data on a social networking site could be directly used to predict consumer behavior, such as purchasing a product at a local retailer, the accuracy of the prediction could be enhanced.

Machine-based tracking techniques, such as the use of cookies employed by many advertising providers for tracking user reactions to products, result in a large volume of data drawn from across many different web sites. However, such data is associated with a particular computing device (e.g., a personal computer), rather than with an individual. In contrast, social networking sites and other login-based systems avoid the problems of multiple people sharing the same computer device, or one person using multiple distinct computer devices.

In general, the different types of data, such as panel data, data from social networks or other web sites with a notion of user identity, and machine-based tracking techniques all have their own distinct advantages and limitations for predicting consumer behavior.

### SUMMARY

Embodiments of the invention combine information from different data sets, such as data from social networking systems, advertising networks, and/or panels corresponding to different web sites. Each of the data sets may comprise demographic information about the users and statistics about the users' past consumer behavior (e.g., product purchases). The data resulting from the combination may be used to compute a prediction model that more accurately predicts the users' consumer behavior than would the use of the data of any given one of the different data sets when taken in isolation.

In one embodiment, the predicted consumer behavior produced by the model for a product comprises predicted consumer actions, such as a total sales value (a number of distinct users estimated to have purchased the product) and a frequency value (a number of times that an average user is estimated to have purchased the product)—for values of a set of demographic attributes of interest. For example, the values of demographic attributes of interest might include a set of age ranges, or males and females. Use of the rich data sets from social networking systems, for example, allows analysis of demographic attributes such as specific interests (e.g., a particular sport, such as tennis), education level, or number of friends, that are entered by users of the social networking systems or inferred based on user activity. Consumer behaviors with respect to combinations of demographic attributes (e.g., males aged 20-24) may also be analyzed.

The data sets are combined using different techniques in different embodiments, resulting in a model that predicts consumer behavior for products for which the consumer behavior have not already been verified. The predicted consumer behavior may include values for the individual demographic attributes and/or combinations thereof, and aggregate values across all demographic groups (e.g., an estimated total number of purchases). The techniques that can be used to produce the model include, for example, supervised learning and Bayesian techniques.

As one specific example, a particular model might output predicted total sales and frequency values of a given product for each of a set of age ranges, for males, for females, for each of a set of education levels (e.g., high school, college, or graduate degrees), and for each of a set of interests, as well as aggregate total sales and frequency values.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a high-level block diagram of a computing environment, according to one embodiment.

FIG. 2 illustrates the computation of a prediction model using data from different data sets, according to one embodiment.

FIG. 3 is a flowchart illustrating steps performed by the statistics module 114 when computing the prediction model and applying the prediction model to predict consumer behavior for a given product, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

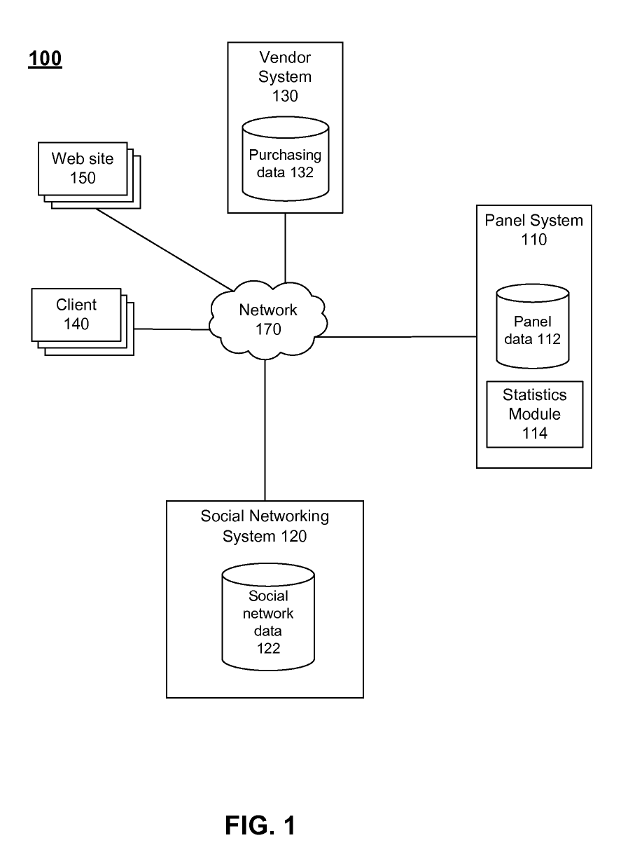

FIG. 1 is a high-level block diagram of a computing environment according to one embodiment. FIG. 1 illustrates a set of distinct data sources 110, 120, 130 storing data obtained based on prior activity of users, a set of client devices 140 used by the users to directly or indirectly provide the data stored by the data sources 110, 120, 130, and a statistics module 114 used to combine and refine the information stored by the data sources 110, 120, 130. FIG. 1 additionally illustrates one or more web sites 150 that provide content that users can view on the client devices 140, such as products, videos, images, and the like.

More specifically, the illustrated data sources include a panel system 110, a social networking system 120, and an vendor system 130. The panel system 110 stores surveying panel data 112, representing the aggregate data provided by a set of households or individual users making up a panel, with respect to a particular web site. As previously described, a surveying panel is a group of people chosen to be statistically representative of the overall audience for some content of interest, such as the viewers of one of the web sites 150. The data tracked for a given panel typically includes information about the number of times that a household in the aggregate, or the individual members of the household, performed consumer behavior, such as purchasing a particular product, on the corresponding web site 150 or through other means, such as purchasing a particular product with a credit card, with cash, with check, at a local grocery store, at a convenience store, or at a gas station. The data for a panel typically further includes general information on the household itself and/or the individual members thereof. For example, in one embodiment the panel data includes product information such as how many times a particular household purchased products on the particular web site 150 or through the methods listed above, and demographic information such as the number of members of the household and the age and sex of each member, the location of the household, aggregate household income, and aggregate purchasing behavior (e.g., particular products purchased). The demographic information associated with the households tends to be highly accurate, since the panel members are surveyed and their answers confirmed before they are accepted as members of the panel. For example, panel members may be asked to scan the product purchased. However, it may be difficult to determine which particular members of the household purchased the product.

As an example of product statistics for one hypothetical set of data, the panel data 112 might include the following, indicating that a first household purchased a first product once and purchased a second product once, and that a second household purchased first product twice:

| Household ID | Product ID | Purchases |
|---|---|---|
| 1 | 1 | 1 |
| 1 | 2 | 1 |
| 2 | 1 | 2 |

Additionally, the panel data 112 in the example would include, for each user, the demographic information related to the households, as described above.

The social networking system 120 stores social network data 122 derived, directly or indirectly, from use of the social network, such as viewing histories of content such as products, videos, images, etc., and social information such as connections and profile information. For example, in one embodiment the social network data 122 comprises, for each distinct individual user, how many times that user was presented with a particular product while using the social network, how many times the user clicked on content including the product, and manually-specified user information. The manually-specified user information is information about the user, including profile information such as user name, age, sex, birthday, interests (e.g., favorite sport or musical genre), and friends or other connections on the social networking system 120. Not all of the user information need be manually-specified by the user; some of the information may be inferred by the social networking system 120 based on user activity or relationships (e.g., inferring that the user is interested in basketball based on frequent postings related to basketball, or on his affiliation with basketball-related organizations on the social networking system). As an example of product statistics for one hypothetical set of data, the social network data 122 might include the following, indicating that a first user was presented with a first product 10 times (clicking it once) and with a second product five times (clicking it once), that a second user was presented with the first product 8 times (clicking it twice), and that a third user was presented with a third product 12 times (clicking it 3 times):

| User ID | Product ID | Impressions | Clicks |
|---|---|---|---|
| 1 | 1 | 10 | 1 |
| 1 | 2 | 5 | 1 |
| 2 | 1 | 8 | 2 |
| 3 | 3 | 12 | 3 |

Additionally, the social network data 122 would include, for each user, profile information and a list of the user's connections.

The social network data 122 represents a strong understanding of user identity, due to the login-based nature of the social networking system 120 which requires some validation of user identity. The social network data 122 may contain inaccuracies due (for example) to user dishonesty when submitting information (e.g., a false age), though this inaccuracy may be mitigated by flagging and correcting possible inaccuracies based on other known data, as described in more detail below. The social network data 122 is typically rich, containing information on attributes that may have a strong influence on consumer behavior patterns, such as number of social network friends and number of books read over some recent time period.

The vendor system 130 aggregates data from internal transactional systems, e.g., via point of sale devices at retailers, transactional data from credit card purchases, and other retail metrics data. The vendor system sells products at retailers, using various methods of payment, such as cash, check, and credit card. The vendor system 130 stores purchasing data 132 that includes, for a particular transaction, a list of products purchased in the transaction. The purchasing data 132 typically lack as strong a notion of user identity as the social network data 122. On the other hand, given that the vendor system 130 usually provides products for a large number of retailers, the purchasing data 132 tends to include data on a large number of purchases of products, resulting in a larger data set. For example, a vendor for a particular brand of laundry detergent may have access to transactional data of purchases of the laundry detergent at several sources of data. This aggregated purchasing data 132 may include a large data set of purchases. However, this large data set of purchases is not statistically representative of populations of people in certain markets.

Users use the client devices 140 to provide data to the data sources 110, 120, 130, either directly or indirectly, and to view content, such as content available on a web site 150. The data may be provided via the network 170, which is typically the Internet, but may also be any network, including but not limited to a LAN, a MAN, a WAN, a mobile, wired or wireless network, a private network, or a virtual private network. It is understood that very large numbers (e.g., millions) of client devices 140 can be in communication with the various data sources 110-130 at any given time. The client devices 140 may include a variety of different computing devices. Examples of client devices 140 include personal computers, mobile phones, smart phones, laptop computers, tablet computers, and digital televisions or television set-top boxes with Internet capabilities. As will be apparent to one of ordinary skill in the art, other embodiments may include devices not listed above. Different types of client devices 140 may be more suited for communicating with different ones of the data sources 110, 120, 130. For example, devices with web browsers, such as personal computers, smart phones, and the like are particularly suited for interacting with the social networking system 120 and the vendor system 130, whereas television set-top boxes may be more suitable for monitoring and providing data to the panel system 110. Not all of the data stored by the various data sources 110-130 need be provided directly by the client devices 140 over the network 170. For example, panel members may provide information to the panel system 110 in response to surveys provided via telephone or physical mail.

The data related to purchasing of products is gathered in different manners for the different data sources 110, 120, 130. For example, the panel data 112 on consumer behavior is usually obtained as a result of user installation of software by members of the panel. Specifically, the members of a household that is part of the panel installs software on (for example) their personal computers, and the software tracks the products that the household members purchase and provides this information to the panel system 110, which stores it as part of the panel data 112. In one embodiment, members of a household manually scan products that have been purchased and the software provides this information to the panel system 110. The social network data 122 related to consumer behavior is captured directly by the social networking system 120, which has knowledge of the accesses to content of its users. The purchasing data 132 related to consumer behavior is obtained by the vendor system 130 tracking purchases of products via internal transactional systems.

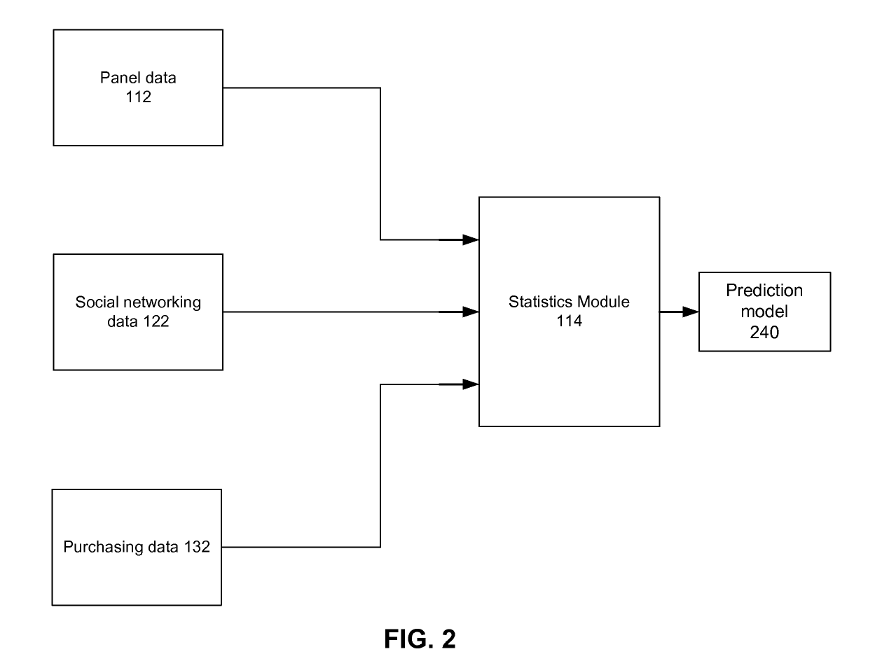

The statistics module 114 computes a prediction model using a combination of data from two or more of the data sources 110, 120, 130. In one embodiment, the statistics module additionally provides predicted consumer behavior for a given product using the prediction model. The operations of the statistics module 114 are discussed further below with respect to FIG. 2.

It is appreciated that FIG. 1 illustrates a computing environment 100 according to one particular embodiment, and that the exact constituent elements and configuration of the computing environment could vary in different embodiments. For example, although FIG. 1 depicts three specific information sources—the panel system 110, the social networking system 120, and the vendor system 130—there could be more or fewer information sources, or information sources of different types. For example, the environment 100 could include only the panel system 110 and the social networking system 120, but not the vendor system 130. As another example, the statistics module 114, although depicted in FIG. 1 as part of the panel system 110, could reside on any system capable of accessing the data stored by the various information sources, such as one of the information sources themselves, or on a separate system that accesses their information via the network 170 or another means.

Specifically, FIG. 2 illustrates the derivation of a model from the data sources 110, 120, 130. The statistics module 114 receives the panel data 112 from the panel system 110, social network data 122 from the social networking system 120, and purchasing data 132 from the vendor system 130. The statistics module 114 then combines the different data using a data integration technique, the specifics of which differ in different embodiments, resulting in a prediction model 240. For example, in one embodiment the statistics module 114 combines the panel data 112 for that web site with the social network data 122.

The combination of the data sets 112, 122, 132 from the different data sources 110, 120, 130 addresses the shortcomings inherent in each data set when it is used in isolation. For example, the panel data 112 for each web site 150 or retailer where the product may be purchased is obtained from a set of users specifically chosen to be statistically representative of the audience which the panel measures, i.e., the audience for that web site or retailer. However, due to the cost of manually selecting the members of the panel, the size of the panel is typically very small, with one panelist representing millions of Americans (for example). In consequence, the panel data 112, though generally representative, tends to be “noisy.” Likewise, the social network data 122 may include data for all of the users of the social network, such as the products presented to the various users through advertisements and how the users reacted to the products (e.g., whether they clicked them). Thus, the social network data 122 may provide a data set that is quite comprehensive and detailed. However, the audience of the social networking system 120 is unlikely to be perfectly representative of the audience for a particular web site 150 or retailer through which products are presented. The purchasing data 132 includes considerable information about how many products purchased across a large group of users. However, the purchasing data 132 do not track the actual identities of the users that purchased the products, but merely the corresponding transactional record identifiers, such as credit card receipts, cash receipts, and check receipts. Thus, consumer behavior with respect to a product in a particular retailer, such as a Target, is not representative of all consumer behavior with respect to the product for all retailers. Thus, using only the social network data 122 (for example) to approximate the predicted consumer behavior of a product on a web site or retailer outside of the social network would result in a higher degree of inaccuracy than if a combination of the social network data 122 and the panel data 112 and/or the purchasing data 132 were used for that purpose, with the panel data/browsing data in effect correcting any lack of representativeness of the social networking data.

In one embodiment, the statistics module 114 need not accept the data provided by the sources 110, 120, 130 as-is, but may instead modify the data for greater accuracy. That is, either the statistics module 114 can modify the data sets provided by the different data sources 110, 120, 130 before combining the data sets, or the content sources themselves can perform the modifications before providing the data sets to the statistics module 114. For example, a portion of the user-entered information within the social network data 122 may be rejected or modified based on other social data associated with that user, where the other social data indicates that the portion is inaccurate. As a specific example, a particular user may list herself in her profile as being 107 years old, but if the majority of her friends are aged 20-24, she has recently listed a college as her current educational institution, and she has a high school graduation date three years prior to the current date, her age might be adjusted to the most probably correct age (e.g., 21) before the statistics module 114 combines the social network data 122 with any other data set.

Different algorithms may be used in different embodiments to perform the derivation of the prediction model 240. For example, possible techniques include supervised machine learning, Bayesian techniques, or weighting segments, each of which is known to one of skill in the art. “Ground truth” may be supplied by, for example, performing a comprehensive survey regarding purchasing of some subset of the products.

The prediction model 240, in essence, maps the consumer behavior for the different data sets 112, 122, 132 used to train the model to a single set of consumer behavior that is more likely to be accurate. Thus, for given consumer products for which actual consumer behavior have not been verified, the consumer behavior produced by the data sources 110, 120, 130 can be provided as inputs to the prediction model 240, which outputs a set of consumer behavior with greater probable accuracy than any input consumer behavior taken in isolation.

In one embodiment, the predicted consumer behavior produced by the prediction model 240 for a given product comprise, for each demographic attribute of interest (or combinations of demographic attributes, such as males aged 15-19), predicted consumer behavior. In one embodiment, the predicted consumer behavior includes the total sales and frequency. As an example for a hypothetical set of data, the consumer behavior could include, in part, the following data, illustrating predicted consumer behavior for various demographic attributes (i.e., age groups 15-19 and 20-25, males, females, and those interested in basketball):

| Attribute | Total Sales | Frequency |
|---|---|---|
| Age 15-19 | 15,282 | 2.83 |
| Age 20-25 | 20,969 | 3.4 |
| Sex: Male | 25,892 | 2.38 |
| Sex: Female | 35,223 | 5.4 |
| Interest: | 12,347 | 1.3 |
| Basketball | | |

Thus, in viewing the predicted consumer behavior of this example, the advertiser associated with the product could determine that the product likely fared considerably better with women than with men, and somewhat better with the age group 20-25 than with the age group 15-19, for example, in addition to determining the estimated total sales and frequency values themselves.

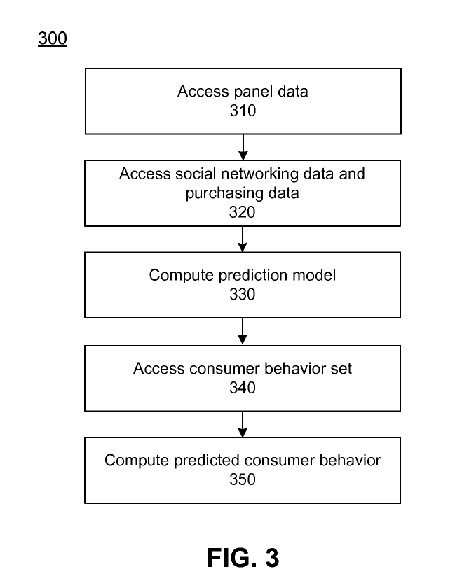

FIG. 3 is a flowchart illustrating steps performed by the statistics module 114 when computing the prediction model 240 and applying the prediction model to compute predicted consumer behavior for a given product, according to one embodiment. In step 310, the statistics module 114 accesses the panel data 112 for the various web sites 150 and retailers. The panel data 112 may be stored locally, as in the embodiment of FIG. 1, or it may be stored remotely, in which case the statistics module 114 may request the data via the network 170. In general, the panel data corresponds to households of viewers, as opposed to corresponding to the individual members of the household. That is, the individual data items specify an association with the household as a whole, not with its individual members. Likewise, in step 320 the statistics module 114 accesses the social network data 122 and purchasing data 132, either locally or remotely via the network 170, depending on the configuration of the environment 100 of the embodiment.

In step 330, the statistics module 114 computes the prediction model from the panel data 112 and the social network data 122 using one of the techniques noted above, such as machine learning or Bayesian techniques. The prediction model can be viewed as being representative of the social network data 122, adjusted by the panel data 112, thereby more perfectly tailoring the social network data and purchasing data to a representative audience.

With the prediction model having been derived, the statistics module 114 can apply the prediction model to estimate the consumer behavior for a given product of interest. Specifically, the statistics module 114 accesses 340 a consumer behavior set, comprising first statistics for the product from the surveying panel, second statistics for the product from the social networking system, and third statistics for the product from the vendor system. These statistics have not been previously verified, e.g. by an in-depth survey, and hence likely contain inaccuracies. The statistics module 114 provides the first, second, and third statistics to the prediction model, thereby computing 350 predicted consumer behavior for display of the product. As described above, such predicted consumer behavior include, for values of each demographic attribute of interest (e.g., various age groups, or male/female groups), predicted consumer behavior, such as the estimated total sales and frequency of the product.

In the foregoing discussion, it is appreciated that a product is merely one type of content, and that the techniques discussed above could likewise be applied for deriving a prediction model for a type of content other than products, and applying that prediction model to content of that type to estimate the content's consumer behavior.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
accessing panel data obtained from a surveying panel and comprising statistics corresponding to households of members;
accessing social networking data obtained from a social networking system and comprising statistics corresponding to individual users of the social networking system;
accessing purchasing data obtained from a vendor system and comprising transactional data related to products for sale; and
computing a prediction model using the panel data, the social networking data, and the purchasing data;

2. The computer-implemented method of claim 1, wherein the purchasing data comprises:
statistics on purchases of products.

3. The computer-implemented method of claim 1, wherein the panel data comprises:
statistics on purchases of products by the households; and
demographic data about ones of the households.

4. The computer-implemented method of claim 1, wherein the social networking data comprises, for each of a plurality of the individual users of the social networking system:
statistics on presentations of products to the user; and
user-specific information about the user specified by the user.

5. The computer-implemented method of claim 4, further comprising:
identifying, for the user, a portion of the user-specific information that other portions of the user-specific information indicate is inaccurate;
determining a probable value for the portion based on the other portions of the user-specific information; and
modifying the portion to the probable value, before deriving the hybrid data.

6. The computer-implemented method of claim 1, further comprising:
accessing first statistics for a product from the surveying panel, second statistics for the product from the social networking system, and third statistics for the product from the vendor system; and
computing predicted consumer behavior for the product at least in part by providing the first statistics, the second statistics, and the third statistics as input to the prediction model.

7. The computer-implemented method of claim 6, wherein the predicted consumer behavior comprise, for each of a plurality of demographic attributes, an estimated total sales value and an estimated frequency value for the product when presented to viewers having the demographic attribute.

8. The computer-implemented method of claim 6, wherein the predicted consumer behavior for the product comprises:
predicted statistics on purchases of the products by users of the social networking system; and
user-specific information about the users specified by the users.

9. A computer-implemented method comprising:
receiving a request for one or more predicted consumer actions for a product of a plurality of products for sale;
retrieving a prediction model using panel data from a surveying panel, social networking data from a social networking system, and purchasing data from a vendor to generate a plurality of prediction scores for a plurality of consumer actions for the product;
determining first statistics for the product from the surveying panel, second statistics for the product from the social networking system, and third statistics for the product from the vendor system;
determining a plurality of prediction scores for the plurality of consumer actions for the product using the prediction model based at least in part on the first statistics, the second statistics, and the third statistics;
selecting one or more consumer actions of the plurality of consumer actions as the one or more predicted consumer actions for the product based on the determined plurality of prediction scores; and
providing the selected one or more predicted consumer actions for the product responsive to the request.

10. The computer-implemented method of claim 9, wherein the panel data comprises a plurality of statistics corresponding to a plurality of households, the plurality of statistics comprising one or more purchase information items about the plurality of products, demographic information about the plurality of households, and identifying information of members of the plurality of households.

11. The computer-implemented method of claim 9, wherein the social networking data comprises a plurality of statistics corresponding to a plurality of users of the social networking system, the plurality of statistics comprising one or more advertisement presentation information items about the plurality of products, user-specified demographic information about the plurality of users of the social networking system, and identifying information of the plurality of users of the social networking system.

12. The computer-implemented method of claim 9, wherein the purchasing data comprises transactional data related to at least one of the plurality of products for sale.

13. The computer-implemented method of claim 9, wherein a predicted consumer action comprises an aggregated value of sales of the product.

14. The computer-implemented method of claim 9, wherein a predicted consumer action comprises an average frequency of purchase of the product for users of the social networking system.

15. The computer-implemented method of claim 9, wherein a predicted consumer action comprises an average frequency of purchasing the product through a web site for users of the social networking system.

16. The computer-implemented method of claim 9, wherein a predicted consumer action comprises an average frequency of purchasing the product at a vendor for users of the social networking system.

17. A computer-implemented method comprising:
maintaining panel data from a surveying panel, where the panel data comprises a first plurality of information items corresponding to a plurality of households;
maintaining social networking data from a social networking system, where the social networking data comprises a second plurality of information items corresponding to a plurality of users of the social networking system;
maintaining purchasing data from a vendor system, where the purchasing data comprises transactional data related to a plurality of products for sale;
determining a prediction model using the panel data, the social networking data, and the purchasing data;
receiving a request for a prediction of consumer behavior for a product of the plurality of products for sale;
retrieving first statistics for the product from the surveying panel, second statistics for the product from the social networking system, and third statistics for the product from the vendor system;
determining the prediction of consumer behavior for the product at least in part by providing the first statistics, the second statistics, and the third statistics as input to the prediction model; and
providing the prediction of consumer behavior for the product responsive to the request.

18. The computer-implemented method of claim 17, wherein a first plurality of information items comprises purchase information by one or more members of the plurality of households about at least one of the plurality of products for sale, wherein a second plurality of information items comprises a plurality of interests of the plurality of users of the social networking system, the method further comprising:
for each member of each household of the plurality of households,
determining one or more confidence scores for one or more users of the social networking system that the member matches the one or more users, and
matching the member to one of the one or more users based on the determined one or more confidence scores;
determining a plurality of interests of the matched users based on the second plurality of information items; and
further determining the prediction of consumer behavior for the product at least in part by providing the determined plurality of interests of the matched users as input to the prediction model.

19. The computer-implemented method of claim 18, wherein the prediction of consumer behavior for a product comprises predicted consumer purchase information filtered by a selected user interest.

20. The computer-implemented method of claim 18, wherein the prediction of consumer behavior for a product comprises consumer purchase information filtered by a selected user demographic.

21. The computer-implemented method of claim 18, wherein the prediction of consumer behavior for a product comprises consumer purchase information filtered by a selected user education level.

22. The computer-implemented method of claim 18, wherein the prediction of consumer behavior for a product comprises consumer purchase information filtered by one or more of a selected interest, a selected user demographic, and a selected user education level.

23. The computer-implemented method of claim 17, wherein the prediction of consumer behavior for a product comprises predicted consumer behavior filtered by user demographics.

24. The computer-implemented method of claim 17, wherein the prediction of consumer behavior for a product comprises predicted consumer behavior filtered by geographic location.

25. The computer-implemented method of claim 17, wherein the prediction of consumer behavior for a product comprises predicted consumer behavior filtered by one or more user attributes in the social networking system.
